(19) United States
(12) Patent Application Publication
(10) Pub. No.: US 2012/0306615 A1
(43) Pub. Date: Dec. 6, 2012

(54) SAFETY SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/169,457

(22) Filed: Jun. 27, 2011

(30) Foreign Application Priority Data
May 30, 2011 (TW) 100118927

(51) Int. Cl. G06F 7/04

(52) U.S. Cl. 340/5.51

(57) ABSTRACT

A safety system for a machine includes a hand identifying module and a control module. The hand identifying module identifies a hand from an image of a movement range of a particular portion of the machine. The control module sends a control signal in response to the identification of the hand from the image, thereby disabling the machine. The disclosure further provides a safety method.

### BACKGROUND

1. Technical Field

The present disclosure relates to safety systems and method, and particularly to a safety system and method for use with a machine with cutting tools.

2. Description of Related Art

An operator could be injured when operating a machine such as a punching machine. For example, if the operator is careless when operating a punching machine his hands or limbs may be damage or severed.

Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a safety system of the present disclosure.

FIG. 2 is a flowchart of an embodiment of a safety method of the present disclosure.

### DETAILED DESCRIPTION

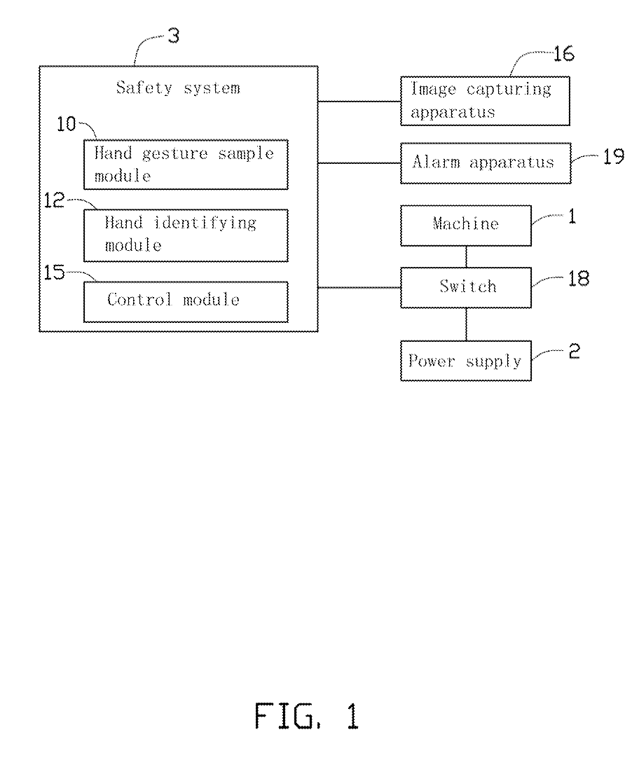

As shown in FIG. 1, a safety system 3 for a machine 1 such as a punching machine includes a hand gesture sample module 10, a hand identifying module 12, and a control module 15. The safety system 3 is capable of stopping the machine 1 from injuring the operator. In this embodiment, the safety system 3 is a stand alone device external to the machine 1. However, in other embodiments, the safety system 3 can be attached to the machine 1.

The hand gesture sample module 10 stores a plurality of sample hand gesture images such as images of a palm, a lateral view of a palm, or a first without the background.

An image capturing apparatus 16 such as a video camera or a camera captures images of a movement range of a cutting tool of the machine 1, and transmits the images to the hand identifying module 12. The image capturing apparatus 16 can be disposed near to or on the machine 1. The hand identifying module 12 compares the images captured by the image capturing apparatus 16 with the sample images of hand gestures stored in the hand gesture sample module 10 to identify a hand-shaped profile from the image. Thereby, determining the appearance of a hand or a portion of a hand in the movement range of the cutting tool of the machine 1. However, in other embodiments, the hand gesture sample module 10 can store a plurality of sample images of finger gestures, and the hand identifying module 12 can identify a finger-shaped profile from the image, thereby determining the appearance of a finger in the movement range of the cutting tool of the machine 1.

When a hand-shaped profile is identified in the image, it is determined that a hand appears within the movement range of the cutting tool of the machine 1. Since the operator can be injured when the operator incautiously puts his/her hands within the movement range of the cutting tool, the control module 15 sends a control signal to the machine 1, thereby stopping the movement of the cutting tool of the machine. In this embodiment, the control module 15 sends the control signal to a switch 18 of the machine 1 to disable the machine 1. The switch 18 is capable of connecting/disconnecting the connection between the machine 1 and a power supply 2. When receiving the control signal from the control module 15, the switch 18 instantly disconnects the connection between the machine 1 and the power supply 2 to power-off the machine 1, thereby protecting the operator from being injured. In other embodiments, the control module 15 can send a control signal merely capable of suspending the operation or the movement of the cutting tool of the machine 1, instead of powering-off the entire machine 1.

In addition, the machine 1 can have an alarm apparatus 19 such as an indicator light. When a hand-shaped profile is identified, the control module 15 further sends an alarm signal to the alarm apparatus 19 to enable the alarm apparatus 19, thereby warning the operator.

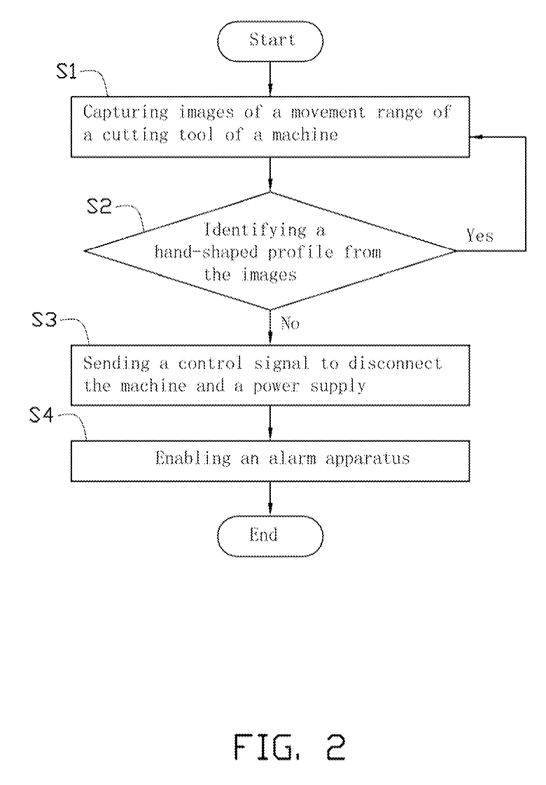

As shown in FIG. 2, a safety method of the present disclosure is as follows. Depending on the embodiment, additional steps may be added, others removed, and the ordering of the steps may be changed.

In step S1, the image capturing apparatus 16 captures images of a movement range of a cutting tool of the machine 1, and transmits the images to the hand identifying module 12.

In step S2, the hand identifying module 12 compares the images captured by the image capturing apparatus 16 with the sample images of hand gestures stored in the hand gesture sample module 10, thereby identifying a hand-shaped profile from the image. However, in other embodiments, the hand identifying module 12 can compare the images captured by the image capturing apparatus 16 with the sample images of finger gestures stored in the hand gesture sample module 10, thereby determining the appearance of a finger in the movement range of the cutting tool of the machine 1. If a hand-shaped profile is identified, step S3 is implemented; otherwise, return to step S1.

In step S3, the control module 15 sends <<If you decide to change, do so in the figure>> a control signal to the switch 18 of the machine 1. When the switch 18 receives the control signal from the control module 15, the switch 18 instantly disconnects the machine 1 and the power supply 2, thereby protecting the operator from being injured. However, in other embodiments, the control module 15 can send a control signal merely capable of suspending the operation or the movement of the cutting tool of the machine 1, instead of powering-off the entire machine 1.

In step S4, the control module 15 sends the alarm signal to the alarm apparatus 19 to enable the alarm apparatus 19, thereby warning the operator.

The disclosed safety system and method utilizes the hand identifying module 12 to analyze the images of the movement range of the cutting tool of the machine 1 which are captured by the image capturing apparatus 16, thereby determining the appearance of a hand in the movement range of the cutting tool of the machine 1. If there is a hand appearing near the cutting tool of the machine 1, the control module 15 instantly directs the switch 18 to disconnect the machine 1 and the power supply 2, thereby protecting the operator from being injured by the machine 1. The control module 15 further enables the alarm apparatus 19 to warn the operator.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A safety system for a machine, comprising:
a hand identifying module identifying at least a portion of a hand from an image of a movement range of a particular portion of the machine; and
a control module sending a control signal in response to the identification of the hand from the image to stop the movement of the particular portion the machine.

2. The system of claim 1, further comprising a hand gesture sample module including a plurality of hand gesture sample images, wherein the hand identifying module compares the image with the hand gesture sample images to identify the hand from the image.

3. The system of claim 1, wherein the control module disables the machine by sending the control signal to a switch of the machine, the switch disconnects the machine from a power supply in response to the control signal.

4. The system of claim 1, wherein the control module sends an alarm signal in response to the identification of the hand from the image to enable an alarm apparatus.

5. The system of claim 1, wherein the particular portion of the machine includes a cutting tool.

6. The system of claim 1, wherein the image is captured by an image capturing apparatus.

7. A safety method for a machine, comprising:
identifying at least a portion of a hand from an image of a movement range of a particular portion of the machine; and
sending a control signal in response to the identification of the hand from the image to stop the movement of the particular portion the machine.

8. The method of claim 7, wherein the step of “identifying a hand” includes:
identifying a hand from an image of a movement range of a particular portion of a machine by comparing the image with a plurality of hand gesture sample images.

9. The method of claim 7, wherein the step of “sending a control signal” includes:
sending a control signal to a switch of the machine in response to the identification of the hand from the image, thereby disconnecting the machine from a power supply.

10. The method of claim 7, further comprising:
sending an alarm signal in response to the identification of the hand from the image to enable an alarm apparatus.
